(19) United States
(12) Patent Application Publication
(10) Pub. No.: US 2012/0198132 A1
(43) Pub. Date: Aug. 2, 2012

(54) NON-VOLATILE MEMORY SYSTEM AND APPARATUS, AND PROGRAM METHOD THEREOF

(75) Inventor: Jung Chul HAN, Ichon-shi (KR)

(73) Assignee: Hynix Semiconductor Inc., Ichon-si (KR)

(21) Appl. No.: 13/188,685

(22) Filed: Jul. 22, 2011

(30) Foreign Application Priority Data
Jan. 31, 2011 (KR) 10-2011-0009812

(51) Int. Cl. G06F 12/00

(52) U.S. Cl. 711/103; 711/E12.008

(57) ABSTRACT

A non-volatile memory system includes a memory area including one or more non-volatile memory apparatuses, and a controller includes a buffer for storing program data, and is configured to transmit a program command and the program data to the memory area and delete the program data stored in the buffer as a program operation is started in the memory area.

### CROSS-REFERENCES TO RELATED APPLICATION

The present application claims priority under 35 U.S.C. §119(a) to Korean application number 10-2011-0009812, filed on Jan. 31, 2011, in the Korean Intellectual Property Office, which is incorporated herein by reference in its entirety as set forth in full.

### BACKGROUND

1. Technical Field

The present invention relates to a semiconductor apparatus, and more particularly, to a non-volatile memory system and apparatus, and a program method thereof.

2. Related Art

A semiconductor memory apparatus has been developed to a stack-type memory apparatus including a plurality of dies stacked therein, in order to maximize the capacity thereof.

The stack-type memory apparatus is introduced, so that it is possible to perform so-called an interleaving operation capable of independently operating a plurality of stacked dies at the same time, resulting in the significant improvement of an operation speed and the like thereof.

FIG. 1 is a diagram illustrating an example of a general stack-type memory system.

As illustrated in FIG. 1, a stack-type memory system 10 includes a host 110 serving as the subject of the operation of the stack-type memory system 10, a controller 120, and a memory area 130. The memory area 130 includes a stack-type memory apparatus in which a plurality of memory apparatuses M1 to Mn are stacked, wherein each of the memory apparatuses M1 to Mn independently operates under the control of the controller 120.

In such a stack-type memory system, the controller 120 performs an interleaving operation under the control of the host 110. For example, when performing a data writing operation with respect to a stack-type memory system in which four memory apparatuses (dies) are stacked, it is possible to simultaneously write data on a first memory apparatus M1 to a fourth memory apparatus M4.

In more detail, when a control signal for data writing, an address signal, data and the like are transmitted from the host 110, the controller 120 stores the data received from the host 110 in a buffer 122. Then, the controller 120 transmits the control signal for data writing and the address signal to the memory apparatuses M1 to M4, and transmits the data stored in the buffer 122 to the memory apparatuses M1 to M4. As the controller 120 sequentially transmits a writing start command to the first to fourth memory apparatuses M1 to M4, the memory apparatuses M1 to M4 are sequentially changed to a busy state, and store the data received from the controller 120 in corresponding memory cells.

In such an interleaving operation, in order to cope with the occurrence of fail during a program operation, it is necessary for the controller 120 to store the data, which has been transmitted the memory apparatuses M1 to M4, in the buffer 122 until a report indicating the completion of the program operation is received from the memory apparatuses M1 to M4. In addition, it is necessary for the controller 120 to store data, which is to be provided for a subsequent interleaving operation, in the buffer 122.

FIG. 2 is a configuration diagram of a buffer included in a general controller.

As illustrated in FIG. 2, the buffer 122 includes a data storage buffer 1221 and a preliminary buffer 1227. The data storage buffer 1221 includes a first data buffer 1223 for a program operation being currently performed, and a second data buffer 1225 for a subsequent program operation.

That is, it can be understood that it is necessary to transfer data of the first data buffer 1223 to the memory apparatuses M1 to M4 for the program operation and then substantially maintain the data in order to cope with the occurrence of an error during the program operation, and it is necessary to provide the second data buffer 1225 for storing data to be received from the host 110 for the subsequent program operation.

FIG. 3 is a diagram explaining a general interleaving operation.

For example, when an interleaving operation is performed with respect to the four memory apparatuses M1 to M4, the controller 120 sequentially transmits data D0 to D3 to the memory apparatuses M1 to M4. Then, as a program start command is transmitted to the memory apparatuses M1 to M4, the memory apparatuses are changed to a busy state. Thus, signals RB0 (Ready/BusyO) to RB3 (Ready/Busy3) are sequentially activated, and a program operation is performed for a designated program time tPROG. For a subsequent program operation, a program operation is performed through the transmission of data D4 to D7, the transmission of a program start command, and the like.

The following description will be given on the assumption that an interleaving operation is performed with respect to the four memory apparatuses, each memory apparatus includes two plains, and one page has a size of 4 KB. In one-time interleaving operation, since it is necessary for the controller 120 to allocate a buffer with a size of 8 KB (the size of one page*the number of plains) to one memory apparatus and to perform the interleaving operation with respect to the four memory apparatuses, four buffers with a size of 8 KB are necessary. Moreover, four buffers with a size of 8 KB are further necessary for a subsequent interleaving operation.

Referring to FIG. 2, it can be understood that the first data buffer 1223 with a size of 8 KB*4 is necessary for a current interleaving operation, and the second data buffer 1225 with a size of 8 KB*4 is necessary for a subsequent interleaving operation. Specifically, the reason for storing data in the first data buffer 1223 is for coping with a fail phenomenon which may occur when an interleaving program operation is performed with respect to the memory area 130.

As described above, since it is necessary for a current memory system to substantially maintain data in the buffer 122 of the controller 120 until a program operation is completed, the size of the buffer 122 increases. Moreover, the size of the buffer 122 increases more and more as the number of dies which may be simultaneously accessed in an interleaving operation. This may cause an increase in the cost of the controller 120.

### SUMMARY

In one embodiment of the present invention, a non-volatile memory system includes: a memory area including one or more non-volatile memory apparatuses; and a controller includes a buffer for storing program data, and is configured to transmit a program command and the program data to the memory area and delete the program data stored in the buffer as a program operation is started in the memory area.

In another embodiment of the present invention, a non-volatile memory apparatus includes: a memory cell array including a plurality of non-volatile memory cells connected between a plurality of word lines and a plurality of bit lines; and a page buffer unit connected to the memory cell array, wherein the page buffer unit comprises: a main latch configured to provide the memory cell array with program data, store data output from the memory cell array, and allow the program data to be loaded when a program operation is performed; and a copy latch configured to copy data of the main latch.

In another embodiment of the present invention, a program method in a non-volatile memory system including a host, a controller operating according to a command of the host, and a memory area operating under a control of the controller, the program method includes the steps of: receiving by the controller a program command and program data, which are transmitted from the host, and storing the program data in a buffer of the controller; transmitting by the controller a control signal and an address signal to the memory area; transmitting by the controller the program data to the memory area; and deleting by the controller the program data of the buffer as a program operation is started in the memory area.

In another embodiment of the present invention, a program method in a non-volatile memory apparatus including a memory cell array connected between a plurality of word lines and a plurality of bit lines, and a page buffer unit, the memory cell array and the page buffer unit being controlled by a controller, the program method includes the steps of: receiving a program control signal and an address signal from the controller; receiving program data provided from the controller; setting the page buffer unit according to the program data and starting a program operation; when fail has occurred after the program operation is started, recovering data of the page buffer unit; and restarting the program operation according to recovered data.

### BRIEF DESCRIPTION OF THE DRAWINGS

Features, aspects, and embodiments are described in conjunction with the attached drawings, in which:

FIG. 1 is a diagram illustrating an example of a general stack-type memory system;

FIG. 2 is a configuration diagram of a buffer included in a general controller;

FIG. 3 is a diagram explaining a general interleaving operation;

FIG. 4 is a configuration diagram explaining a non-volatile memory system according to an embodiment;

FIG. 5 is a configuration diagram of a buffer included in the controller illustrated in FIG. 4;

FIG. 6 is a diagram explaining the concept of program data recovery according to an embodiment;

FIG. 7 is a diagram explaining an example of a threshold voltage distribution of a multi-level cell in a non-volatile memory system according to an embodiment;

FIG. 8 is a flowchart explaining a program method according to an embodiment;

FIG. 9 is a flowchart explaining an example of the recovery process illustrated in FIG. 8; and

FIG. 10 is a flowchart explaining a program method according to another embodiment.

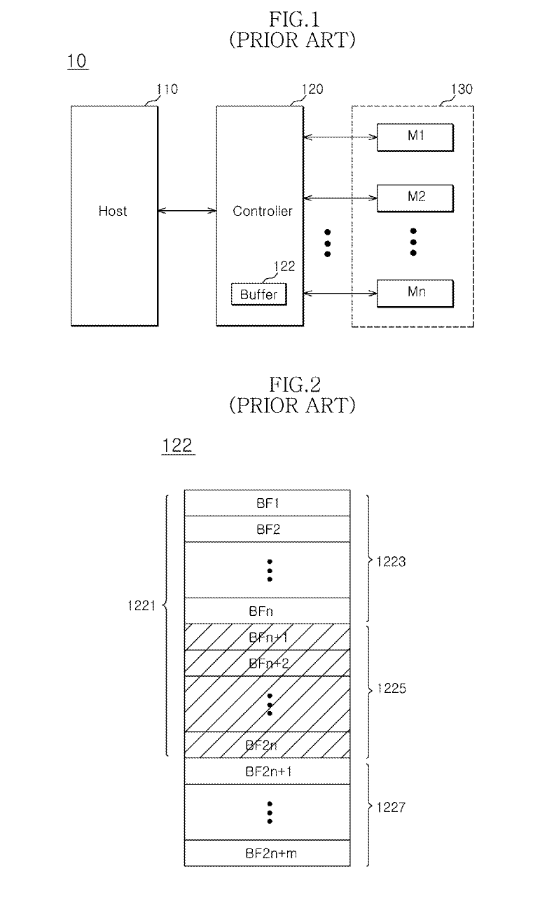

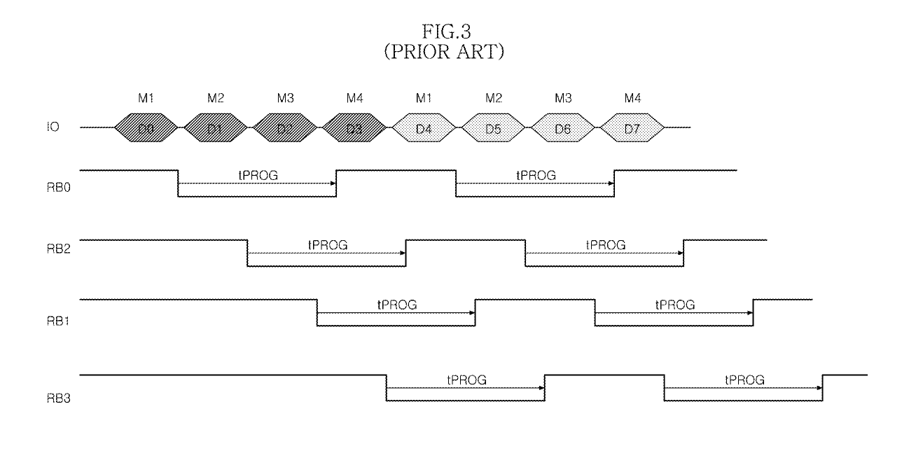

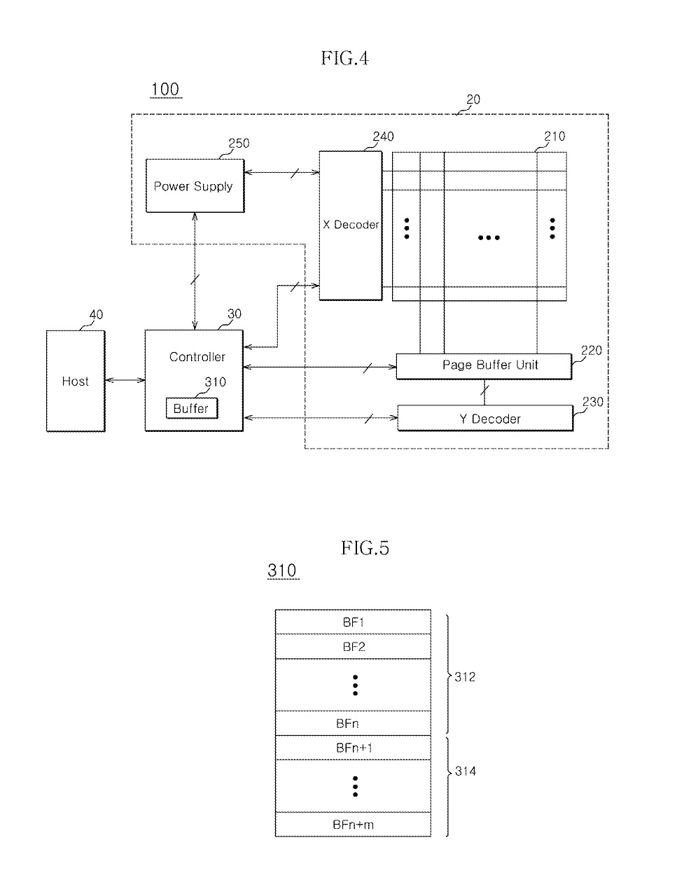

### DETAILED DESCRIPTION

Hereinafter, a non-volatile memory system and apparatus, and a program method thereof according to the present invention will be described in detail with reference to the accompanying drawings through exemplary embodiments.

FIG. 4 is a configuration diagram of a non-volatile memory system according to an embodiment.

As illustrated in FIG. 4, a non-volatile memory system 100 includes a host 40 serving as the subject of the operation of the non-volatile memory system 100, a controller 30 for controlling the entire operation of the non-volatile memory system 100, and a memory area 20 operating under the control of the controller 30.

The memory area 20 may include a plurality of memory apparatuses with a stack configuration.

In addition, each memory apparatus constituting the memory area 20 includes a memory cell array 210, a page buffer unit 220, a Y decoder 230, an X decoder 240, and a power supply 250.

A plurality of memory cells (for example, flash memory cells) for storing data are connected to the memory cell array 210, and specifically, are connected to the memory cell array 210 in a matrix format between word lines WL for selecting and activating the memory cells and bit lines BL for inputting/outputting data of the memory cells.

The page buffer unit 220 includes a plurality of page buffers connected to the memory cell array 210 through the bit lines BL, and provides program data to memory cells selected from the memory cell array 210 or reads data from the memory cells selected from the memory cell array 210 and stores the read data.

The Y decoder 230 is configured to provide a data input/output path to page buffers of the page buffer unit 220 under the control of the controller 30, and the X decoder 240 is configured to select the word lines WL of the memory cell array 210 under the control of the controller 30.

The power supply 250 is configured to generate an operating voltage according to operation modes (program, erase and read) under the control of the controller 30, and supply the generated operating voltage to the word lines WL or the page buffer unit 220 through the X decoder 240.

In addition, the controller 30 includes a buffer 310. The controller 30 according to the embodiment is configured to receive a control signal for data writing, an address signal, data and the like from the host 40 in a data writing operation and store the data received from the host 40 in the buffer 310. Then, the controller 30 is configured to transmit the control signal for data writing and the address signal to the memory area 20 and transmit the data stored in the buffer 310 to the memory area 20. In addition, after transmitting the data stored in the buffer 310 to the memory area 20, the controller 30 deletes the data stored in the buffer 310. Since data to be written on the memory area 20 is transmitted to the memory area 20 and then is deleted from the buffer 310, an empty space exists in the buffer 310, and data for a subsequent data writing operation may be received from the host 40 and stored in the empty space.

Meanwhile, as the controller 30 transmits a writing start command to the memory area 20, the memory area 20 is changed to a busy state and data received from the controller 30 is stored in a corresponding memory cell of the memory area 20.

It is possible for the non-volatile memory apparatus according to the embodiment to perform an interleaving operation. In such a case, the size of the buffer 310 is determined according to the size and number of memory apparatuses which are simultaneously accessed. That is, the size of the buffer 310 may be determined by the number of plains constituting one memory apparatus*the size of one-page data*the number of dies which are simultaneously accessed.

Specifically, in the embodiment, the data of the buffer 310 is transmitted to the memory area 20 and then is deleted from the buffer 310. That is, the data of the buffer 310 is not substantially maintained until a data writing operation for the memory area 20 is completed, and data for a subsequent interleaving operation is stored in an area of the buffer 310 from which the data has been deleted. Consequently, it is possible to minimize the size of the buffer 310, resulting in the reduction in the manufacturing cost of the non-volatile memory system 100.

Since data is transmitted from the buffer 310 to the memory area 20 and then is deleted, it is necessary to cope with a fail phenomenon which may occur during a program operation. In the embodiment, when fail has occurred, it is possible for the page buffer unit 220 to recover data under the control of the controller 30, which will be described in detail later.

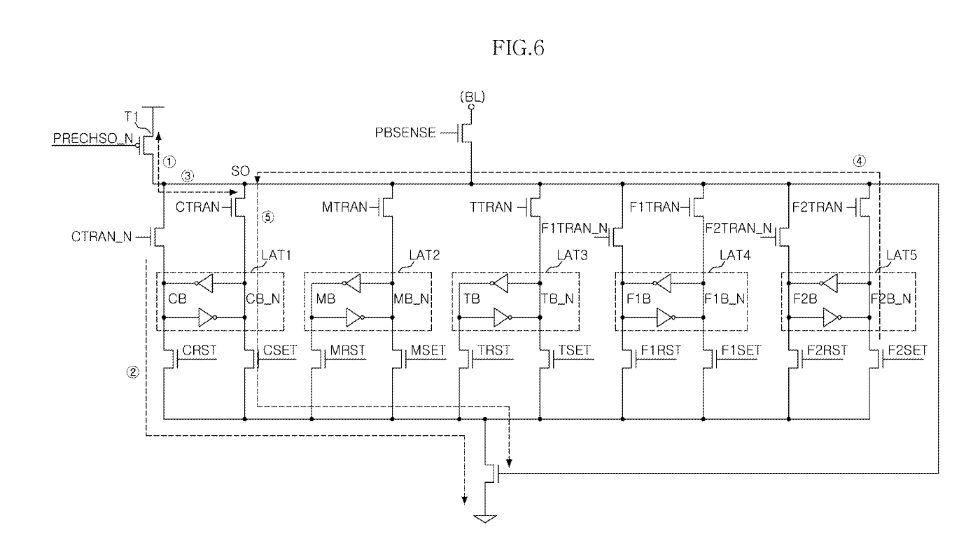

FIG. 5 is a configuration diagram of the buffer included in the controller illustrated in FIG. 4.

Referring to FIG. 5, the memory area 20 has a stack configuration, and the buffer 310 includes data storage areas BF1 to BFn (312) which correspond to the number n of memory apparatuses which are simultaneously accessed. The sizes of the buffer areas BF1 to BFn constituting the data storage area 312 are determined by the number of plains constituting one memory apparatus*the size of one-page data. For example, when one memory apparatus includes two plains and the size of one-page data is 4 KB, one buffer area has a size of 8 KB. In addition, four buffer areas with a size of 8 KB may be provided for an interleaving operation for simultaneously accessing four memory apparatuses.

Moreover, the buffer 310 further includes a preliminary area 314, and the sizes of the buffer areas BFn+1 to BFn+m of the preliminary area are determined when designing the buffer.

The controller 30 including the buffer 310 as described above transmits data in the data storage area 312 to each memory apparatus for a program operation through interleaving. Furthermore, the controller 30 deletes the data in the data storage area 312 at a predetermined time point, for example, when a busy signal is received from the memory apparatus 20.

Program data for a subsequent interleaving operation is written in the data storage area 312 from which the data has been deleted. Such program data may be received from the host 40. In such a case, the host 40 checks the buffer 310 of the controller 30, and immediately inputs subsequent program data when the buffer 310 is empty.

Meanwhile, the data transmitted from the controller 30 is loaded to each page buffer of the page buffer unit 220. Then, the initial value of a latch is set by the data loaded to the page buffer, and a program operation is performed.

The program operation may be variously performed according to whether the memory apparatus 20 includes a single level cell or a multi-level cell. However, the program operation is basically through a program and verification process.

When data has not been normally programmed in a memory cell during the program operation, that is, when program fail has occurred, the page buffer unit 220 of the embodiment recovers data to be programmed using the data received from the controller 30.

FIG. 6 is a diagram explaining the concept of program data recovery according to the embodiment.

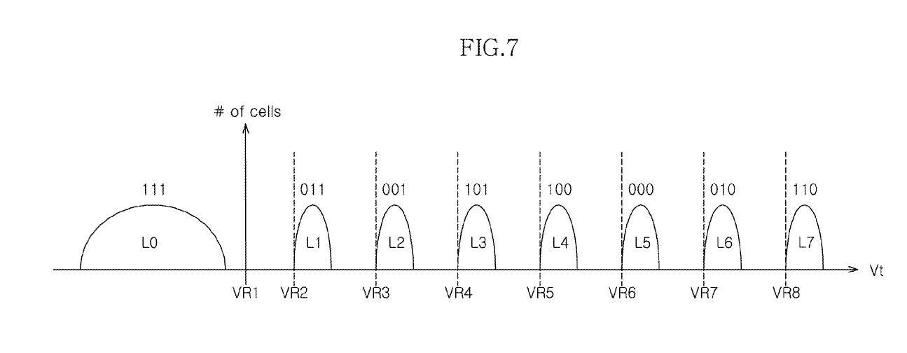

In the embodiment, one page buffer includes five latches LAT1 to LAT5. However, the invention is not limited thereto. Using such a page buffer, it is possible to program a plurality of threshold voltage distributions of a memory cell. For example, it is possible to program 3-bit data in one memory cell, which will be described with reference to FIG. 7 below.

FIG. 7 is a diagram explaining an example of a threshold voltage distribution of a multi-level cell in a non-volatile memory system according to the embodiment.

When 3-bit data is programmed in one memory cell, distributions of threshold voltages VR1 to VR8 of the memory cell according to the levels of data to be written are as illustrated in FIG. 7. The levels of data indicated by the memory cell according to the threshold voltages VR1 to VR8 may be changed as the occasion demands. In addition, it may be possible to variously change a program order for creating 3-bit data from the initial state of the memory cell.

A program and verification operation is repeated in order to write multi-level data as illustrated in FIG. 7 using the page buffer illustrated in FIG. 6, and data having been read after programming a specific bit may be stored in the latch of the page buffer, that is, the second to fourth latches LAT2 to LAT4. Thus, data provided from the buffer 310 of the controller 30 is stored in the first latch LAT1 according to a program command of the controller 30, and is copied into the fifth latch LAT5 through a latch setting process. Furthermore, data having been read through the verification operation during programming the multi-level data is stored in the second to fourth latches LAT2 to LAT4. In other words, data copied from the original data (the data received from the buffer 310) is stored in the fifth latch LAT5, and the data stored in the second to fourth latches LAT2 to LAT4 may be changed during the program and verification operation. Consequently, when program fail has occurred due to sudden power-off and the like, it is possible to recover the original data, which is to be programmed, using the data stored in the fifth latch LAT5 into which the original data has been copied.

Referring again to FIG. 6, it can be understood that one page buffer includes the five latches LAT1 to LAT5. Specifically, the first latch LAT1 operates as a main latch that stores data transmitted from the controller 30 or provides data to the controller 30.

Data provided from the controller 30 for a program operation is stored in the first latch LAT1 and then is copied into one of the second to fifth latches LAT2 to LAT5 through a latch setting process. In the embodiment, copy data may be stored in the fifth latch LAT5. Data copied into the fifth latch LAT5 as a copy latch may have a level substantially equal to that of the data stored in the first latch LAT1, a level inverse to that of the data stored in the first latch LAT1, or a level obtained by changing that of the data stored in the first latch LAT1 according to predetermined rules.

Then, the power supply 250 is configured to apply a program voltage corresponding to the level of the data copied into the fifth latch LAT5 to the bit lines BL, so that a program operation is performed. For example, when the data copied into the fifth latch LAT5 is at a logic high level 1, the power supply 250 applies a program inhibition voltage VCC to the bit lines. When the data copied into the fifth latch LAT5 is at a logic low level 0, the power supply 250 applies a program voltage VSS to the bit lines.

Through the program operation and the verification process as described above, data having been read as a verification result may be stored in the second to fourth latches LAT2 to LAT4.

Meanwhile, when fail has occurred during the program operation, it is necessary to recover the data provided from the buffer 310 of the controller 30 and perform the program operation again. In the conventional art, since program data is substantially maintained in a buffer until the program operation is completed, it is possible to receive the program data from the buffer of the controller again and perform the program operation again. However, in the embodiment, when the memory area 20 is changed to a busy state, since the data of the buffer is deleted, data to be programmed is recovered using the data loaded to the page buffer 220. Such a recovery process is possible because the data transmitted to the first latch LAT1 has been copied into the fifth latch LAT5.

In more detail, when program fail has occurred, a sensing node SO is first precharged \textcircled{1}. To this end, a first switching element T1 is turned on by activating a sensing node precharge signal PRECHSO_N, and then the first switching element T1 is turned off by deactivating the sensing node precharge signal PRECHSO_N.

Next, the first latch LAT1 as the main latch is discharged \textcircled{2}. To this end, a first reset signal CRST is activated for a predetermined time and then deactivated to discharge a first node CB.

Thus, after the first latch LAT1 is discharged, the sensing node SO is discharged \textcircled{3} by activating the sensing node precharge signal PRECHSO_N for a predetermined time and then deactivating the sensing node precharge signal PRECHSO_N.

After the sensing node SO is discharged, data of the fifth latch LAT5 including host data copied thereto is transferred to the sensing node SO \textcircled{4}. In order to transfer the data of the fifth latch LAT5 to the sensing node SO, a fifth latch data transmission signal F2TRAN may be activated for a predetermined time and then deactivated.

Then, data of the sensing node SO is stored in the first latch LAT1 \textcircled{5}. To this end, a first setting signal CSET is activated for a predetermined time and then deactivated.

Data initially provided to the first latch LAT1 in a data writing operation has been copied into the fifth latch LAT5. Consequently, when the program fail has occurred, the data of the fifth latch LAT5 is moved to the first latch LAT1 again, so that data recover can be performed. When data is recovered to the first latch LAT1, a latch setting process is performed again, and then a program operation is restarted.

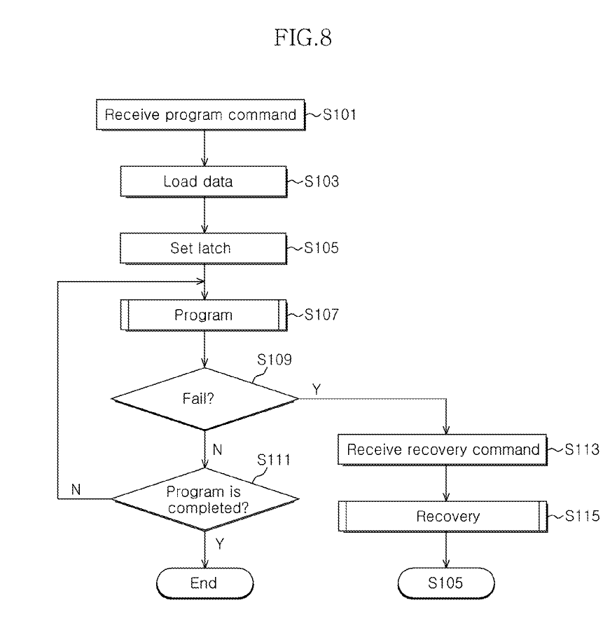

FIG. 8 is a flowchart explaining a program method in terms of a memory area according to the embodiment.

A program command is received in the memory area 20 from the controller 30 (S101), and data is transmitted from the buffer 310 of the controller 30 to the page buffer unit 220 of the memory area 20, that is, the first latch LAT1 illustrated in FIG. 6 (S103).

Next, the page buffer unit 220 copies the data into the fifth latch LAT5 through a latch setting process (S105). At this time, the data copied into the fifth latch LAT5 may have a level substantially equal to that of the data loaded to the first latch LAT1, a level inverse to that of the data stored in the first latch LAT1, or a level obtained by changing that of the data stored in the first latch LAT1 according to predetermined rules.

When the latch setting process is completed, a program operation is started (S107). In each memory cell, single-level data or multi-level data may be written, and the program operation is basically performed through a program and verification process.

Meanwhile, program fail may occur due to sudden power-off and the like during the program operation. In this regard, the controller 30 checks whether the program fail has occurred in the memory area 20 during the program operation (S109).

As a result of the check, when the program fail has not occurred, the controller 30 checks whether the program operation has been completed (S111). When the program operation has not been completed, the program operation is continuously performed.

Meanwhile, when the program fail has occurred, the memory area 20 receives a data recovery command from the controller 30 (S113). Then, the page buffer unit 220 recovers data to be programmed according to a predetermined procedure (S115).

FIG. 9 is a flowchart explaining an example of the recovery process illustrated in FIG. 8.

When data recovery is necessary due the occurrence of fail during a program operation, the sensing node SO is first precharged (S201). Referring to FIG. 6, the first switching element T1 is turned on by activating the sensing node precharge signal PRECHSO_N, and then the first switching element T1 is turned off by deactivating the sensing node precharge signal PRECHSO_N, so that it is possible to precharge the sensing node SO.

Next, the first latch LAT1 as the main latch is discharged in order to allow data to be recovered to the first latch LAT1 (S203). That is, the first reset signal CRST is activated for a predetermined time and then deactivated to discharge the first node CB.

After the first latch LAT1 is discharged, the sensing node SO is precharged (S205) and data of the fifth latch LAT5 is transferred to the sensing node SO (S207). To this end, the fifth latch data transmission signal F2TRAN may be activated for a predetermined time and then deactivated.

Then, the data transferred to the sensing node SO is transferred to the first latch LAT1 (S209). To this end, the first setting signal CSET is activated for a predetermined time and then deactivated.

As a consequence, data copied into the fifth latch LAT5 is transferred to the first latch LAT1 again, so that it is possible to recover data to be programmed. After the data is recovered in this way, a subsequent program operation is performed by returning to the latch setting process (S105).

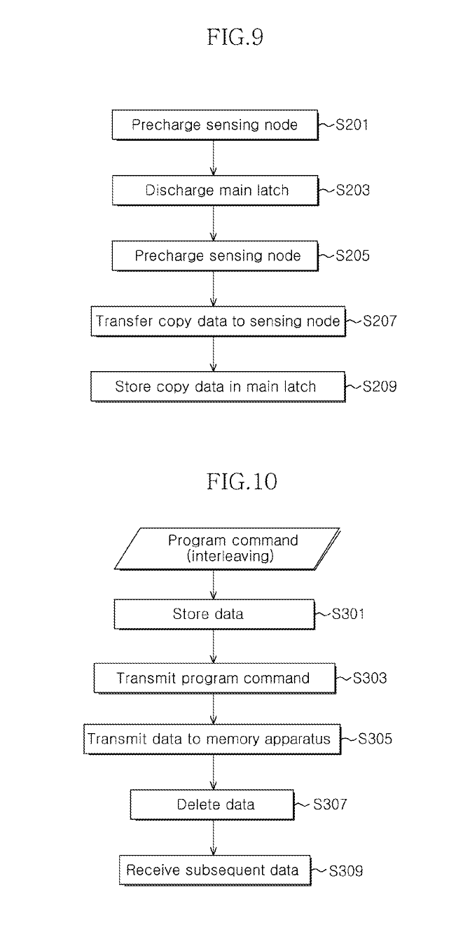

FIG. 10 is a flowchart explaining a program method in terms of a controller according to another embodiment. In addition, in the embodiment, a program operation may be performed by an interleaving operation.

As a program command including a control signal for data writing, an address signal, data and the like is received from the host 40, the controller 30 stores data transmitted from the host 40 in the buffer 310 (S301).

Next, the controller 30 transmits the program command including the control signal for data writing and the address signal to the memory area 20 (S303), and transmits data stored in the buffer 310 to the memory area 20 (S305). When the program operation is performed by the interleaving operation, the data of the buffer 310 may be transmitted to respective memory apparatuses constituting the memory area 20.

Then, as the memory area 20 transmits a state change signal, which indicates that the memory area 20 has changed to a busy state by the start of the program operation, the controller 30 deletes the data stored in the buffer 310 (S307).

The host 40 periodically checks the buffer 310 of the controller 30, and transmits data for a subsequent program operation to the controller 30 when the buffer 310 is empty due to the deletion of the data. Thus, the controller 30 receives the data from the host 40, and stores the received data in the buffer 310 (S309).

As described above, the controller 30 according to the embodiment transmits data to be programmed to the memory area, and deletes data of the buffer when the memory area is in a busy state without including a buffer area for storing data necessary for a current program operation separately from a buffer area for storing data necessary for a subsequent program operation, thereby allowing data necessary for a subsequent program operation to be stored.

Consequently, it is possible to minimize the size of the buffer, thereby significantly reducing the manufacturing cost of the non-volatile memory system.

The memory area copies data transmitted from the controller and recovers the copied data as data to be programmed when an unexpected program fail phenomenon has occurred. Consequently, it is possible for the page buffer unit 220 of the memory area 20 to recover data by itself and restart a program operation without performing a process of receiving data from the controller 30 again.

As a consequence, it is possible to flexibly cope with a program fail phenomenon while minimizing the size of the buffer required by the controller 30.

While certain embodiments have been described above, it will be understood to those skilled in the art that the embodiments described are by way of example only. Accordingly, the non-volatile memory system and apparatus, and the program method thereof described herein should not be limited based on the described embodiments. Rather, the non-volatile memory system and apparatus, and the program method thereof described herein should only be limited in light of the claims that follow when taken in conjunction with the above description and accompanying drawings.

What is claimed is:

1. A non-volatile memory system comprising:
a memory area including one or more non-volatile memory apparatuses; and
a controller includes a buffer for storing program data, and is configured to transmit a program command and the program data to the memory area and delete the program data stored in the buffer as a program operation is started in the memory area.

2. The non-volatile memory system according to claim 1, wherein the controller is configured to delete the program data of the buffer in response to a change signal to a busy state, which is transmitted from the memory area.

3. The non-volatile memory system according to claim 1, wherein the controller is configured to store subsequent program data in the buffer after deleting the program data.

4. The non-volatile memory system according to claim 1, wherein the memory area comprises:
a page buffer unit configured to store the program data transmitted from the controller,
wherein the page buffer unit comprises:
a main latch to which the data transmitted from the controller is loaded; and
a copy latch into which data of the main latch is copied.

5. The non-volatile memory system according to claim 4, wherein the controller is configured to transmit a recovery command to the memory area when fail occurs during a program operation, and the memory area is configured to transfer data of the copy latch to the main latch in response to the recovery command.

6. A non-volatile memory apparatus comprising:
a memory cell array including a plurality of non-volatile memory cells connected between a plurality of word lines and a plurality of bit lines; and
a page buffer unit connected to the memory cell array,
wherein the page buffer unit comprises:
a main latch configured to provide the memory cell array with program data, store data output from the memory cell array, and allow the program data to be loaded when a program operation is performed; and
a copy latch configured to copy data of the main latch.

7. The non-volatile memory apparatus according to claim 6, wherein the page buffer unit comprises:
a latch section including the main latch and the copy latch, which are connected in parallel between a sensing node connected to the bit lines and a ground terminal,
wherein, when program fail occurs, the page buffer unit transfers data of the copy latch to the main latch and restarts the program operation.

8. The non-volatile memory apparatus according to claim 7, wherein the latch section comprises:
one or more temporary buffer configured to store data having been read according to a program verification operation.

9. A program method in a non-volatile memory system including a host, a controller operating according to a command of the host, and a memory area operating under a control of the controller, the program method comprising the steps of:
receiving by the controller a program command and program data, which are transmitted from the host, and storing the program data in a buffer of the controller;
transmitting by the controller a control signal and an address signal to the memory area;
transmitting by the controller the program data to the memory area; and
deleting by the controller the program data of the buffer as a program operation is started in the memory area.

10. The program method according to claim 9, wherein the controller is configured to delete the program data in response to a change signal to a busy state, which is transmitted from the memory area.

11. The program method according to claim 9, wherein the host periodically checks a state of the buffer of the controller, and when the controller deletes the program data, the host transmits program data for a subsequent program operation to the controller.

12. A program method in a non-volatile memory apparatus including a memory cell array connected between a plurality of word lines and a plurality of bit lines, and a page buffer unit, the memory cell array and the page buffer unit being controlled by a controller, the program method comprising the steps of:
is receiving a program control signal and an address signal from the controller;
receiving program data provided from the controller;
setting the page buffer unit according to the program data and starting a program operation;
when fail has occurred after the program operation is started, recovering data of the page buffer unit; and
restarting the program operation according to recovered data.

13. The program method according to claim 12, wherein the page buffer unit comprises:
a main latch to which the data transmitted from the controller is loaded; and
a copy latch into which data of the main latch is copied,
wherein, in the step of recovering the data, data of the copy latch is transferred to the main latch.

14. The program method according to claim 12, wherein the page buffer unit includes a latch section including a main latch and a copy latch, which are connected in parallel between a sensing node connected to the bit lines and a ground terminal, and
the step of recovering the data comprises:
primarily precharging the sensing node;
discharging the main latch;
secondarily precharging the sensing node;
transferring data of the copy latch to the sensing node; and
transferring the data transferred to the sensing node to the main latch.
